(19) United States
(12) Patent Application Publication
(10) Pub. No.: US 2005/0080974 A1
(43) Pub. Date: Apr. 14, 2005

(54) BRIDGE CONTROLLER CONNECTING AN IDE HOST AND A USB DEVICE

(76) Inventor: Ju-Yung Lin, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/707,394

(22) Filed: Dec. 10, 2003

(30) Foreign Application Priority Data
Sep. 29, 2003 (TW) 092126898

(51) Int. Cl. G06F 13/36

(52) U.S. Cl. 710/315

(57) ABSTRACT

A bridge controller connects to an integrated drive electronics (IDE) slave interface and a universal serial bus (USB) host or a USB on-the-go (OTG) controller. The bridge controller includes an IDE slave interface for connecting a first system, a USB interface for controlling a USB device, and a control unit electrically connected to the IDE slave interface and the USB interface for transforming IDE transmission data, commands, or status inputted from the IDE slave interface into USB transmission data, commands, or status, and outputting them to the USB interface, and transforming USB transmission data, commands, or status inputted from the USB interface into IDE transmission data, commands, or status, and outputting them to the IDE slave interface.

### BACKGROUND OF INVENTION

1. Field of the Invention

The present invention relates to a bridge controller, and more particularly, to a bridge controller connecting an IDE host and a USB device.

2. Decription of the Prior Art

The univeral serial bus (USB) interface is one of the commonest interface standards of digital wired communications. There is at least one USB Series “A” female connector in standard PC interfaces. Any peripheral device that has a standard USB interface, for example, a USB mouse with a standard USB Series “A” male connector, or a digital camera with a standard USB interface, is capable of connecting any computer which has a standard USB Series “A” female connconnector tonsmit information in the US1.1 or USB 2.0 format. According to the advantages of high transmission rate and the ability to plug-and-play, there is a trend to equip products with standard USB inteinterfaces. Some the commonest applications are digital cameras, external USB flash cards, and external hard disks.

Nowadays, the convenience of USB devices is also utilized in audio-and-video (AV) systems such as vias videopact disk (VCD) players, digital versatile disk (DVD) players, or magnetic optical players. However, only a USB host or a USB on-the-go (OTG) interface can access and control USB devices. Consequently, an AV system must have a built-in USB host or USB OTG controller to accesses a USB storage device. However, this costs a lot of resources, and the complexity of the technology required is increased. For common AV systems, there are only IDE interfaces built into them. Therefore, a peripheral controller interface (PCI) or other special kind of interface has to be provided to connect to a USB host or a USB OTG controller, then through the USB host/OTG the AV system can control the USB device. Hence, these systems have to support the USB host/OTG and the USB device, which is another heavy burden. Please refer to FIG. 1. FIG. 1 is a block diagram of an of an or information system 10 accessing and controlling a USB device 40 according to the prior art. The AV system 10 can directly connect to an IDE device 20 and access it by an IDE bus 71. In contrast with connecting to an IDE device, if the AV system 10 is required to access a USB device 40, it has to provide a PCI interface or other special connecting interface, and utilize a bus 81 to connect this interface to a like interface of a USB host/OTG 30. Then the USB host/OTG 30 can connect and control the USB device 40 by a USB bus 91. In the prior art, the AV system 10 can only connect and access the USB device 40 in this way.

### SUMMARY OF INVENTION

It is therefore a primary objective of the claimed invention to provide a bridge controller connecting an IDE host and a USB device.

Briefly described, the claimed invention disc discloses adge controller connecting an integrated drive electronics (IDE) host and a universal serial bus (USB) host or a USB on-the-go (OTG) controller. The bridge controller includes an IDE slave interface for connecting a first system, a USB interface for controlling a USB device, and a control unit electrically connected to the IDE slave interface and the USB interface for transforming IDE transmission data, commands, or status inputted from the IDE slave interface into USB transmission data, commands, or status, and outputting them to the USB interface, and transforming USB transmission data, commands, or status inputted from the USB interface into IDE transmission data, commands, or status, and outputting them to the IDE slave interface.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of an of anio-and-video system accessing and controlling a USB device according to the prior art.

FIG. 2 is a block diagram of a bridge controller according to the present invention.

FIG. 3 is a block diagram of a first system accessing and controlling a USB device according to the present invention.

### DETAILED DESCRIPTION

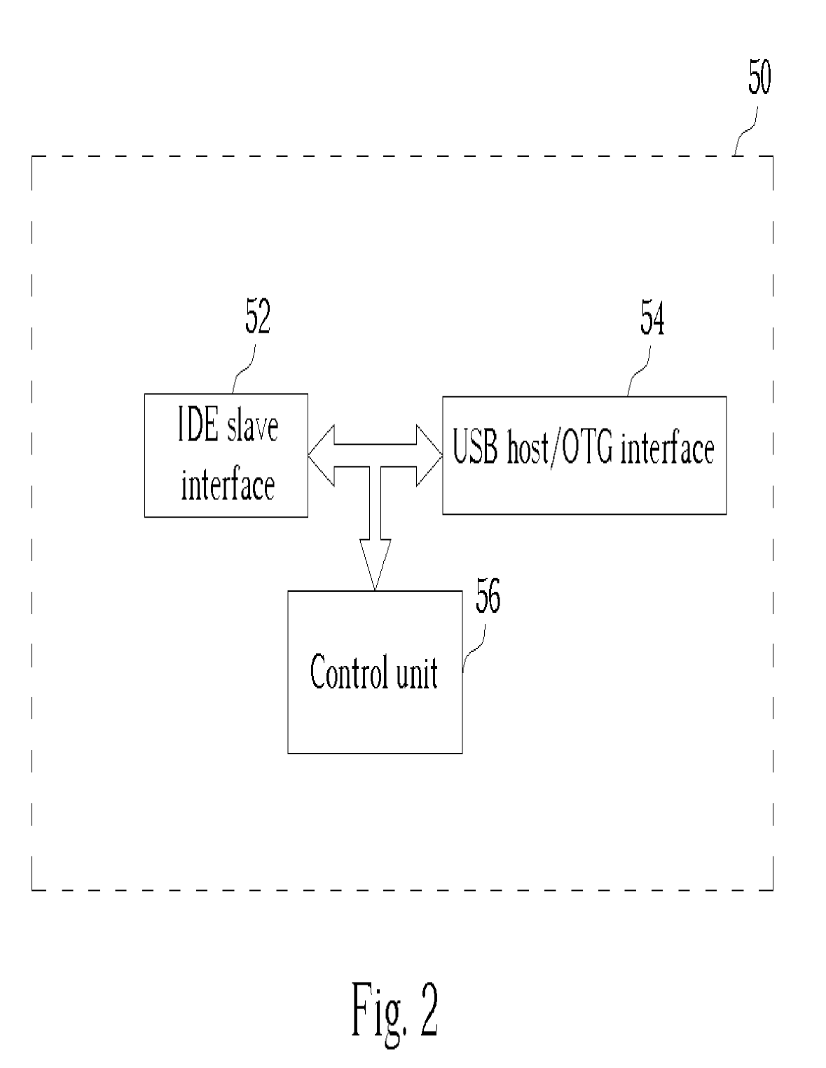

Please refer to FIG. 2. FIG. 2 is a block diagram of the bridge controller 50 according to the present invention. The bridge controller 50 includes an IDE slave interface 52, a USB host/OTG interface 54, and a control unit 56. The IDE slave interface 52 is electrically connected to the control unit 56 and the USB host/OTG interface 54, and is capable of connecting to a system with an IDE interface through an IDE bus, which is quite common in AV systems. The USB host/OTG interface 54 is electrically connected to the control unit 56 and the IDE slave interface 52, and is capable of connecting to a USB device through a USB bus. The control unit 56 is electrically connected to the IDE slave interface 52 and the USB host/OTG interface 54. The control unit 56 is utilized to transform the type of the transmission data, command, or status between the IDE slave interface 52 and the USB host/OTG interface 54. In the claimed invention, when a system with an IDE interface is required to access a USB device, it can be connected to the IDE slave interface 52 in the bridge controller 50 of the present invention through an IDE bus, and the bridge controller 50 will transform IDE transmission data, commands, or status inputted from the IDE slave interface 52 into USB transmission data, commands, or status. The USB host/OTG interface 54 is connected to the USB device through a USB bus and outputs the USB transmission data, commands, or status to the USB device through the USB host/OTG interface 54. Hence, the AV system can access and control the USB device. The control unit 56 is also utilized to transform USB transmission data, commands, or status inputted from the USB host/OTG interface 54 into IDE transmission data, commands, or status, and output them to the connected system through the IDE slave interface 52. The control unit 56 may be an embedded microprocessor or a programming code. Besides, since the IDE slave interface 52 and the USB host/OTG interface 54 are electrically connected to each other, the information of which the format does not need to be transformed can be transmitted between the IDE slave interface 52 and the USB host/OTG interface 54 directly. Consequently, the system utilizing the bridge controller 50 does not need to connect to a USB host or a USB OTG controller by a PCI bus to access and control a USB device, but connect to the bridge controller 50 by its original IDE interface directly.

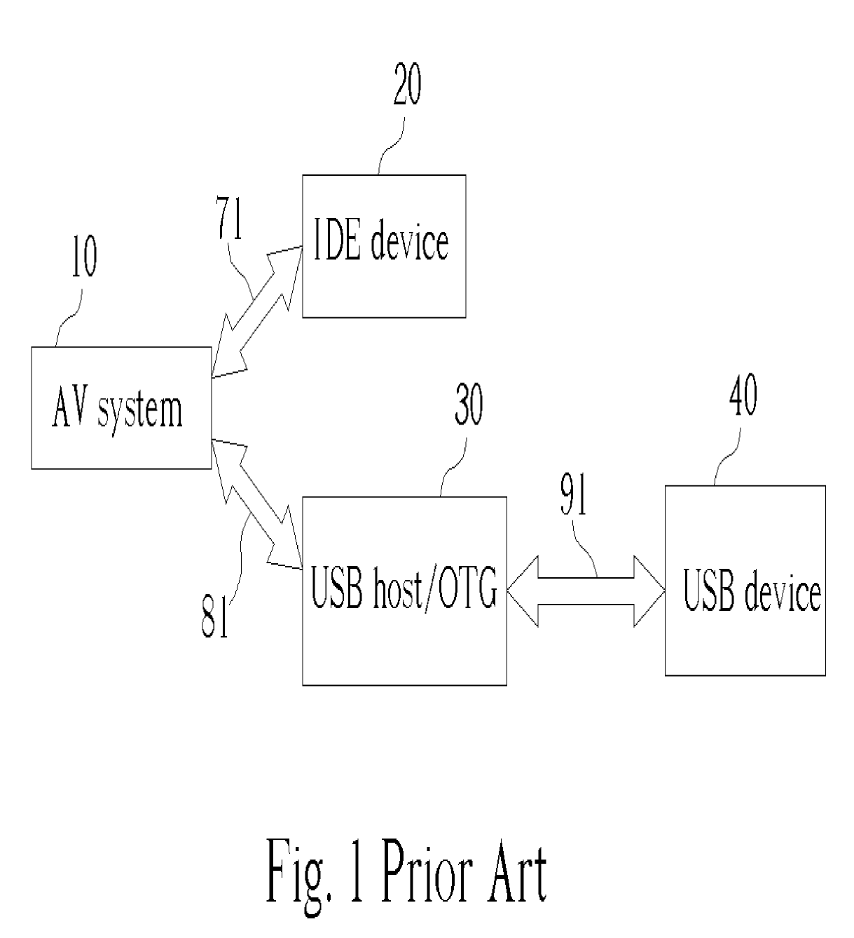

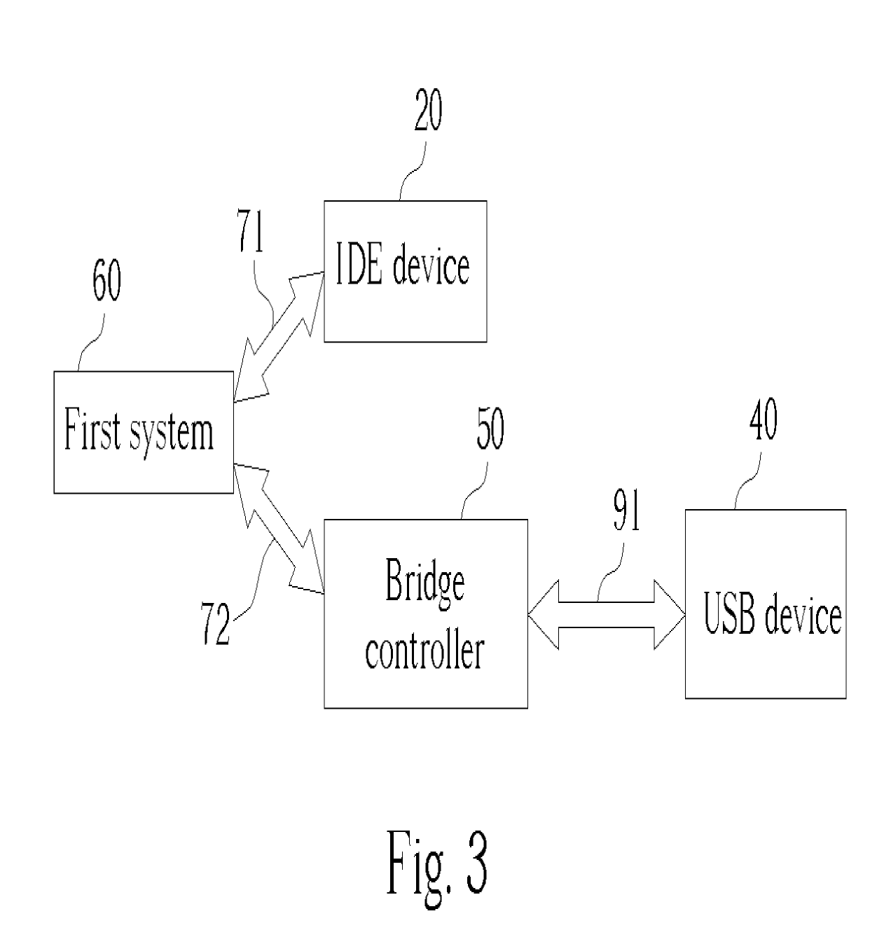

Please refer to FIG. 3. FIG. 3 is a block diagram of a first system 60 of the present invention accessing and controlling a USB device 40 according to the present invention. The first system 60 has an IDE interface as in a normal AV system. When the first system 60 is required to access the USB device 40, it is connected to the bridge controller 50 of the present invention, which is illustrated in FIG. 2, by an IDE bus 72 through its IDE interface. The bridge controller 50 is further connected to the USB device 40 by a USB bus 91. The bridge controller 50 of the present invention is capable of transforming transmission data, commands, or status of IDE formats and USB formats in the control unit 56, so that the first system 60 does not need to have a PCI interface or other special interface and a USB driver to connect to a USB host/OTG and access the USB device 40 through the USB host/OTG as in the AV system 10 according to the prior art in FIG. 1. For example, when applying the bridge controller 50, a DVD player 60 can be connected to the bridge controller 50 directly by the IDE bus 72, the bridge controller 50 then being connected to an external USB hard disk 40 in which a movie is stored through a USB bus 91. The bridge controller 50 transforms the commands and status in the IDE format inputted from the DVD player to those in the USB format and transmits them to the external USB hard disk 40. The bridge controller 50 also transforms a USB status from the external USB hard disk 40 to an IDE status and transmits this to the DVD player 60. Then it is able to transmit the movie data stored in the USB external hard disk to the DVD player to play through the bridge controller 50. The aforementioned DVD player is one of the embodiments of the present invention. The first system 60 in the present invention may be a VCD player, a DVD player, a magnetic optical player, or any AV system.

The present invention discloses a bridge controller connecting an IDE host and a USB device. The bridge controller includes an IDE slave interface, a USB interface, and a control unit. The bridge controller facilitates communication between IDE interfaces, which are common in AV systems, and USB devices, which are the mainstream at present. With the bridge controller of the present invention, the system with an IDE interface does not need a built-in USB interface to access and control a USB device, and does not need to provide a PCI interface or any special interface to connect to a USB host/OTG for accessing and controlling a USB device. In contrast, system connects to the bridge controller of the present invention and accesses and controls the USB device through the bridge controller.

Those skilled in the art will readily observe that numerous modifications and alterations of the device may be made while retaining the teachings of the invention. Accordingly, the above disclosure should be construed as limited only by the metes and bounds of the appended claims.

1. A bridge controller comprising:
an integrated drive electronics (IDE) slave interface for connecting a first system;
a universal serial bus (USB) interface for controlling a USB device; and
a control unit electrically connected to the IDE slave interface and the USB interface for bridge controlling transmission data, commands, and status between the IDE slave interface and the USB interface.

2. The bridge controller of claim 1 wherein the IDE slave interface is electrically connected to the USB interface.

3. The bridge controller of claim 1 wherein the USB interface is a USB host interface.

4. The bridge controller of claim 1 wherein the USB interface is a USB on-the-go (OTG) interface.

5. The bridge controller of claim 1 wherein the control unit is an embedded microprocessor.

6. The bridge controller of claim 1 wherein the control unit is a programming code.

7. The bridge controller of claim 1 wherein the control unit is a state machine.

8. The bridge controller of claim 1 wherein the control unit is further capable of transforming an IDE transmission data, command, or status inputted from the IDE slave interface into a USB transmission data, command, or status and outputting it to the USB interface; and transforming a USB transmission data, command, or status inputted from the USB interface into an IDE transmission data, command, or status, and outputting it to the IDE slave interface.

9. The bridge controller of claim 1 wherein the first system is a chipset of an audio and video (AV) system.

10. The bridge controller of claim 1 wherein the first system is a chipset of an information system.

11. The bridge controller of claim 1 wherein the first system is a chipset of a video compact disk (VCD) player.

12. The bridge controller of claim 1 wherein the first system is a chipset of a digital versatile disk (DVD) player.

13. The bridge controller of claim 1 wherein the first system is a chipset of a portable audio and video system.
